(19) United States
(12) Patent Application Publication
(10) Pub. No.: US 2025/0167698 A1
(43) Pub. Date: May 22, 2025

(54) Accelerometer Controlled Rotating Motor Speed System and Method of Operation

(71) Applicants: Jerry Robichaux, Orlando, FL (US); Nurcan Robichaux, Orlando, FL (US)

(72) Inventors: Jerry Robichaux, Orlando, FL (US); Nurcan Robichaux, Orlando, FL (US)

(21) Appl. No.: 18/514,485

(22) Filed: Nov. 20, 2023

(51) Int. Cl. H02P 6/06; A01G 20/47; G01P 1/02; G01P 15/00; G01P 15/18

(52) U.S. Cl. CPC H02P 6/06; A01G 20/47; G01P 1/023; G01P 15/003; G01P 15/18

(57) ABSTRACT

The system of has one accelerometer, one motor, one signal processor, one electronic motor speed controller, a power switch, a power source, a housing and a handle. The user controls the attitude orientation of the device by manipulating the handle. The accelerometer is connected to the housing or handle, and detects the acceleration due to gravity in at least one axis of the housing or the handle. The accelerometer communicates with the signal processor. The signal processor determines a commanded operating motor speed based on a preprogrammed schedule of one or more accelerometer output signals and sends the commanded operating motor speed to an electronic motor speed controller. The electronic motor speed controller controls the speed and direction of the motor according to the commanded speed and direction of the signal processor. The power switch activate the device based on the switch ON/OFF position.

### FIELD OF THE INVENTION

The present invention relates generally to using an accelerometer output to determine the commanded rotating motor speed. Specifically, the present invention uses an accelerometer to control the operating point of a motorized device.

### BACKGROUND OF THE INVENTION

Electronically controlled motorized devices are commonly used by individuals and businesses on a daily basis to complete tasks with less effort. These handheld motorized devices are portable, are battery powered and utilize an electric motor to turn or rotate an implement that the device uses to accomplish a specific task. Examples of these devices include but are not limited to outdoor powered equipment such as weed trimmers, vacuums and leaf blowers, and devices with motorized wheels that can self-propel the device in the forward, backward, left or right directions. These devices are often used for tasks that require a level of precision or control, and they can be used in a variety of settings, including industrial, commercial, and household settings. Many of these handheld devices the user must use the index finger to repeatedly depress a mechanical or electrical trigger on the handle of the motorized device to control the speed and direction of the motor for the device to perform its desired function. Unfortunately, the same hand and index finger used to support the weight and manipulate the position and attitude orientation of the device is also being used to precisely depress the trigger. As a consequence, the index finger is less available to be used to support the manipulation of the device, with the remaining fingers being used to manipulate the device, thus reducing the grip strength available to manipulate the device. Because of the weight of the device and the hand and finger forces applied, prolonged use can result in injury or muscle fatigue in the hand and fingers, or loss of dexterity when the trigger is constantly engaged in order to properly utilize and control the device. More ergonomic trigger mechanisms and trigger locks are methods that are commonly used to mitigate the risks to the user, however these methods add significant cost and complexity to the device, reduce the device's reliability, and do not completely eliminate the risks of prolonged use. A novel approach is described in this invention that seeks to eliminate the trigger and latching mechanisms, and instead utilize an accelerometer as a sensor to sense the resulting attitude orientation of the device that is already being manipulated by the user's hand, and automatically control the speed and direction of the motor, or plurality of motors of the device based on the sensed attitude orientation. The result is that the user can now use the entire hand to control the operating motor speed and direction by manipulating the attitude orientation of the device in the manner required to accomplish the desired task that the device was designed for, improving the ergonomics while reducing the cost and improving the reliability of the device. The ergonomics are improved because effort to required manipulate the attitude orientation of the device can be used to control the speed and direction of the motors in the device, and not require additional effort by the user's finger to precisely and repeatedly manipulate a trigger mechanism with the same hand. The reliability is improved because the accelerometer replaces multiple moving parts associated with a trigger and latching mechanisms, and the accelerometer can be housed in a protected location away from moisture and dust. The cost is reduced because modern 3 axis accelerometer integrated circuits are inexpensive and can be integrated with existing electronics, in some cases without the need for external remote wiring or can be integrated with a separate circuit card assembly that is packaged or located in an ideal location internal to the housing or handle of the device with minimal wiring.

### BRIEF DESCRIPTION OF THE DRAWINGS

FIG. 1 is a block diagram of the present invention.

FIG. 2 is a flow diagram of the signal processor.

FIG. 3 is a flow diagram of the present invention.

FIG. 4 is an illustration of a device with an accelerometer.

FIG. 5 is a diagram of the pre-programmed motor operating speed versus accelerometer reference signal.

FIG. 6 is an illustration of an accelerometer reference signal between R0 and R1.

FIG. 7 is an illustration of an accelerometer reference signal greater than R1 diagram of the present invention.

FIG. 8 is an illustration of a backpack leaf blower with accelerometer in the handle.

FIG. 9 is an illustration of the exit tube is approximately horizontal.

FIG. 10 is an illustration of the exit tube oriented towards the ground.

FIG. 11 is a diagram of the alternate schedule of motor operating speed versus accelerometer reference signal.

FIG. 12 is an illustration of the device is a portable canister vacuum with accelerometer internally mounted in the housing.

FIG. 13 is an illustration of a portable vacuum device with accelerometer indicating device is oriented horizontal with motor rotating at a lower speed not generating suction.

FIG. 14 is an illustration of the device oriented horizontally downward with motor rotating at higher speed to create suction.

FIG. 15 is an illustration of the device with oriented horizontally upward motor commanded to stop rotating to allow for the user to empty the canister.

FIG. 16 is an illustration of a device with two independently controlled motorized wheels, accelerometer, signal processor, motor speed controller, and battery.

FIG. 17 is a diagram of the motor speed forward and reverse schedule.

FIG. 18 is an illustration of the horizontal orientation for Forward speed command.

FIG. 19 is an illustration of the horizontal orientation for tilted forward, for a wheel speed command set to zero.

FIG. 20 is an illustration of the device slightly tilted back or pointing upwards for maximum forward speed command.

FIG. 21 is an illustration of the device with a larger upward orientation for reverse speed, speed command.

FIG. 22 is an illustration of the device with a large upward orientation for a wheel speed command set to zero.

FIG. 23 is an illustration of the device orientation is vertical in orientation, Accelerometer reference signal is between R3 and R4 limits.

FIG. 24 is an illustration of the device orientation is tilted to the right of vertical orientation, Accelerometer reference signal is between R4 and R7 limits.

FIG. 25 is an illustration of the device orientation is tilted to the left of vertical orientation, Accelerometer reference signal is between R0 and R3 limits.

FIG. 26 is a diagram of the programmable schedule for wheel speed ratio.

FIG. 27 is a flow diagram of the signal processor detailed process.

### DETAIL DESCRIPTIONS OF THE INVENTION

All illustrations of the drawings are for the purpose of describing selected versions of the present invention and are not intended to limit the scope of the present invention.

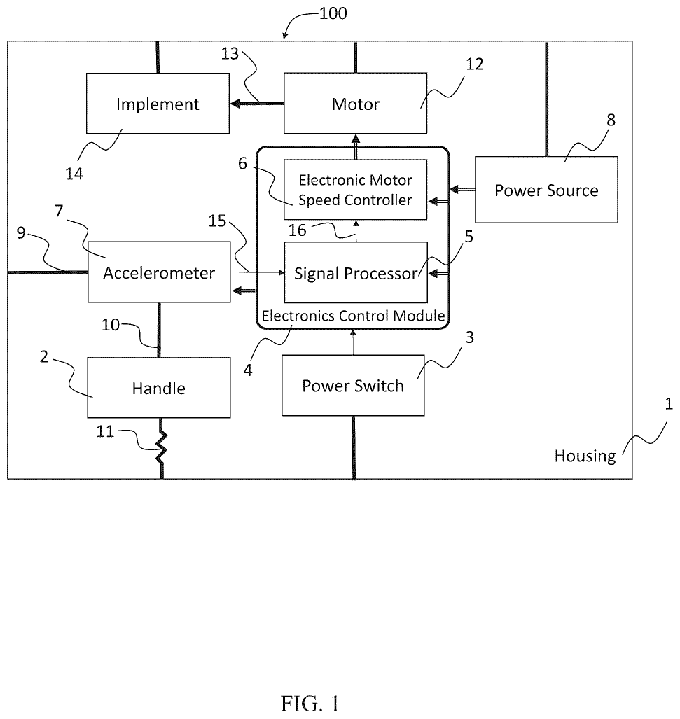

As described in FIG. 1, the preferred embodiment of the system 100 of the present invention comprises at least one housing (1) that is mechanically connected to a user manipulated handle (2). Adjacent to the housing, there is at least one Power Switch (3) that provides an ON/OFF signal to the at least one Electronics Control Module (4) that contains a Signal Processor (5) and an Electronic Motor Speed Controller (6). The Signal Processor (5) is an electronics device that receives and processes the output signals of the Accelerometer (7) in order to determine the attitude orientation of the accelerometer to form an Accelerometer Reference Signal in the selected direction of interest, which will be explained in more detail in the following paragraphs. The Power Switch (3) is the single source that activates or deactivates the Device (100). The Electronics Control Module (4) receives the Power Switch (3) ON/OFF signal and activates the Device (100) when the Power Switch is in the ON state by providing conditioned power from the Power Source (8) to the Accelerometer (7), the Signal Processor (5) and the Electronic Motor Speed Controller (6). The Device (100) contains a Power Source (8) that is an electrical source of voltage and current. In the preferred embodiment, the Power Source (8) is a rechargeable battery. In alternate embodiments the Power Source (8) is from an Alternating Current power source such as 110V AC electrical power. When the Power Switch (3) is in the OFF state, the Electronics Control Module (4) deactivates the Device (100) by removing power from the Power Source (8) from the Accelerometer (7), the Signal Processor (5) and the Electronic Motor Speed Controller (6). When the Device (100) is activated, the Signal Processor (5) periodically and continuously receives acceleration signals from the Accelerometer (7) that is mechanically connected to the housing (1). In an alternate embodiment the Accelerometer is mechanically connected to the handle (2). In either embodiment, the Accelerometer (7) provides acceleration measurements in at least one axis, but preferably in three orthogonal directions referred to as X, Y and Z directions. In the first embodiment, the Accelerometer (7) is located within the housing (1) and mechanically coupled (9) to the housing (1) in such a fashion that the mechanical coupling (9) aligns the Accelerometer (7) acceleration outputs in a fixed orientation with the Housing (1) such that the output of the Accelerometer (7) will provide acceleration signals to the Signal Processor (5) so that the Signal Processor (5) can determine the attitude orientation of the housing (1) based on the output signals of the Accelerometer (7). In an alternate embodiment, the Accelerometer (7) is located within the handle (2) and mechanically coupled to the handle (2) in such a fashion that the mechanical coupling (11) aligns the Accelerometer (7) acceleration measurements in a fixed orientation with the Handle (2). The alignment is fixed in a manner such that the output of the Accelerometer (7) will provide acceleration signals to the Signal Processor (5) so that the Signal Processor (5) can determine the attitude orientation of the Handle (2) based on the output signals of the Accelerometer (7). In an alternate embodiment, the Handle (2) is mechanically coupled (11) to the Housing (1), with the mechanical coupling made flexible so that the user can manipulate the position and attitude orientation of the Handle (2) without significantly affecting the attitude orientation of the Housing (1) of the Device (100) in order for the Device (100) to achieve its desired task. When the Device (100) is activated, the Signal Processor (5) continuously and periodically receives at least one Accelerometer Output Signal (15) from the Accelerometer (7) and processes the Accelerometer Output Signal (15) in order to determine a Motor Reference Speed for one or more motors, and then provides the commanded Motor Reference Speed signal (16) as an output to one or more Electronic Motor Speed Controllers (6). The Electronic Motor Speed Controller (6) then applies power in the form of voltage and Current from the Power Source (8) to the Motor (12) phase windings in order to regulate the Motor rotational speed to the quantity determined by the Motor Reference Speed Signal (16). The rotating shaft of the Motor (12) is mechanically coupled (13) to at least one Implement (14), which rotates with the motor rotating shaft in order to accomplish the task the device was designed for. Examples of Implements (14) include but are not limited to a rotating fan that creates air flow or suction, wheels that propel the Device (100) in the forward or reverse directions, and wheels that are independently driven to propel the Device (100) in the forward or reverse directions, and the left or right directions.

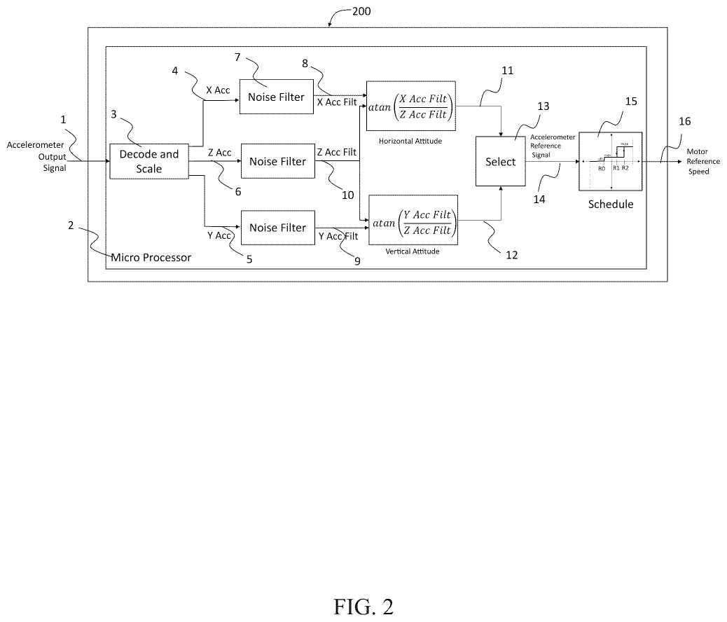

Referring to FIG. 2, in the preferred embodiment, the Signal Processor (200) consists of a Micro Processor (2) with software that continuously and periodically receives at least one Accelerometer Output Signal (1). The Accelerometer Output (1) is periodically sampled by the Micro Processor (2) at a chosen rate that is appropriate for the application, and may occur at a frequency of 1 sample per second up to thousands of samples per second. The periodically sampled Accelerometer Output Signal (1) is then processed with a Decode and Scale (3) operation. The Accelerometer output signal format can be either an analog voltage signal, or be an encoded serial data message. For the analog voltage signal format, each Accelerometer Output Signal (1) are decoded and scaled to create an Acceleration in the sense axis of the Accelerometer. In the preferred embodiment shown in FIG. 2, there are three separate Accelerometer Output signals, one for each orthogonally arranged sense axes. In an alternate embodiment, the Accelerometer has only one sense Axis, and provides one Accelerometer Output Signal (1) which is a measure of acceleration in the primary sense axis of the Accelerometer. In either embodiment, each Accelerometer output is converted from analog to digital by an analog to digital converter that is provided as a hardware function in the Micro Processor (2). The converted digital signal is then processed by the Micro Processor (2) software by first subtracting the accelerometer specific 0 g offset reference value, and the remaining digital value is then multiplied by the accelerometer specific scale factor to determine the acceleration in units of g's for each output of the Accelerometer to create an acceleration reference for each sense axis of the accelerometer. For Accelerometers that output a serial data message, the Accelerometer output signal is an encoded serial message, and decoding requires buffering the sampled serial data for each axis and converting the sampled serial data according to the format that is specific to the accelerometer to finally get acceleration in g's for each sense axis of the accelerometer. After the Decode and Scale (3) operation is complete, the Signal Processor (200) has acceleration signals for each sense axis of the accelerometer, referred to as the X Acc (4), Y Acc (5) and Z Acc (6). In the preferred embodiment, the next stage of signal processing involves applying a Noise Filter (7) to each acceleration signal. The Noise Filter (7) is a digital Finite Impulse or Infinite Impulse response filter that processes the sampled X Acc (4), Y Acc (5) and Z Acc (6) signals in order to reduce high frequency content due to electrical noise or unwanted mechanical vibration, in order to create a suitable signal for determining the attitude orientation of the Accelerometer. Ideally this is a digital low pass filter with choice of cutoff frequency that is selected to reduce unwanted electrical noise and mechanical vibration, and provide a smooth and responsive signal for X, Y, Z accelerations, depicted as X Acc Filt (8), Y Acc Filt (9), and Z Acc Filt (10). Once the filtered accelerations are determined, then an Accelerometer Reference signal (14) can be determined based on the filtered acceleration signals (8), (9) and (10). In the preferred embodiment, the filtered acceleration signals are processed to determine the attitude orientation of the accelerometer resulting from the calculation of the arc tangent of two filtered accelerometer signals. According to the orientation of the Accelerometer which will be depicted in later Figures, to determine the Horizontal Attitude (11), the arc tangent of the ratio of the X Acc Filt (8) divided by the Z Acc Filt (10) signals is calculated. To determine the Vertical Attitude (12), the ratio of the arc tangent of the Y Acc Filt (9) divided by the Z Acc Filt (10) is calculated. The desired orientation attitude reference is then Selected (13) to form an Accelerometer Reference Signal (14) which is applied to a Schedule (15) to determine a commanded Motor Reference Speed (16) which will be an output of the Signal Processor (200), and provided as an input to an Electronic Motor Speed Controller (6) in FIG. 1. The Schedule (15) is tailored based on the device and the implement that the motor is rotating. Further, depending on the implement and the device application, one or motors may be controlled based on one or more calculated attitude orientations of the accelerometer and applied to one or more Schedules (15) to create one or more Motor Reference Speed (16) commands. In an alternate embodiment, the at least one Accelerometer Output Signal (1) is Decoded and Scaled (3), then processed with a Noise Filter (7), to create one Filtered Acceleration Signal (8, 9 or 10), which is selected (13) to create an Accelerometer Reference Signal (15), and provided as an input to at least one Schedule (15) to determine at least one Motor Speed Reference (16) as an output of the Signal Processor (200) and provided as an input to at least one Electronic Motor Speed Controller (6) in FIG. 1. The at least one Schedule (15) is tailored based on the device and the implement(s) that the motor(s) are rotating. Further, depending on the implement and the device application, one or motors are controlled based the Accelerometer Reference Signal (14) and applied to one or more Schedules (15) to create one or more Motor Reference Speed (16) commands.

Referring back to FIG. 1, after the Signal Processor (5) processes the outputs of the Accelerometer (7) and determines a Motor Reference Speed (16), a Motor Reference Speed signal is provided as an input signal to the Electronics Motor Speed Controller (6). The Motor Speed Controller (6) then regulates the amount of power in the form of voltage or current to the Motor (12) in order to regulate the rotating speed and direction of the Motor (12) rotating shaft to the quantity determined by the output of the Signal Processor (5). The Motor (12) has a rotating shaft that is Mechanically Coupled (13) to an Implement (14) associated with the device (100). The Mechanical Coupling (13) can be a shaft coupler, or gear train of sufficient design as to mechanically transfer the rotating speed of the motor shaft to a rotating speed of the Implement (14). The Implement (14) is the unique apparatus, tool, utensil, or piece of equipment that the Device (100) is designed to employ in order to serve a particular purpose. Examples of an Implement (14) include but are not limited to a rotating fan that moves air or a fluid, a string trimmer's rotating head, a blade, or a motorized wheel. All such Implements (14) are designed to perform a specific function that requires the user to control the operating rotational speed and direction of the motor (12). A plurality of Electrical Connections, provide electrical interconnections and the transfer of power or electrical signals between the Electronic Control Module (4), the Accelerometer (7), Power Switch (3), the Signal Processor (5), the Power Source (8), the Electronic Motor Speed Controller (6), and the Motor (12) in order for each element to provide the functions as described. With the arrangement of elements described in FIG. 1, the user can effectively manipulate the attitude orientation of the device with Handle (2) in order to control the operating speed and direction of the Motor (12) and Implement (14), provided that the Signal Processor (5) has an appropriate pre-programmed schedule of speed and direction as a function of Accelerometer (7) Output Signals (15).

As previously described, the Signal Processor (5) processes the output of the Accelerometer (7) based on pre-programmed schedules designed to provide an appropriate motor operating speed and direction of rotation, which are tailored to the application of the device (100). When the accelerations due to lateral motion of the housing are sufficiently small, the outputs of the accelerometer can be processed to determine the orientation of the housing due to the sensed acceleration due to gravity in units of g's. By processing the output measurements for acceleration along each sense axis, the attitude orientation of the Housing (1) or Handle (2) with respect to an inertial reference frame in the X, Y and Z axes can be determined. The preprogrammed schedule within the Signal Processor (5) can be simple or complex, depending on the application of the device.

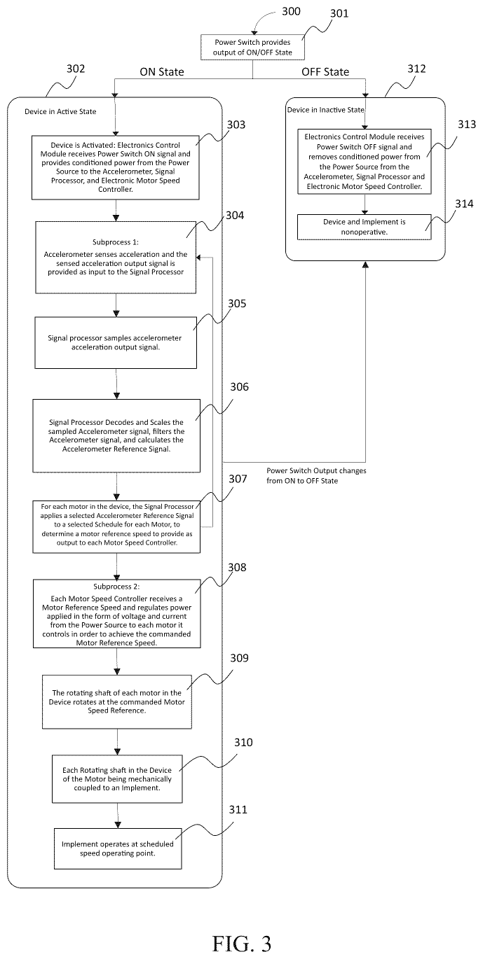

As can be seen in FIG. 3, the method of operation for system 300 of the present invention will now be described. The method begins with the Power Switch providing an ON/OFF State output signal (301). If the Power Switch State is in the ON state, the method branches to the Device in the Active State (302). If the Power Switch State is in the OFF state, the method branches to the Device in the Inactive State (312). For the Device in Active State (302), the method continues with step (303) the Electronics Control Module receiving the Power Switch ON state signal and the Electronic Control Module provides conditioned power from the Power Source to the Accelerometer, Signal Processor and Electronic Motor Speed Controller. The method then continues to step 304 with Subprocess 1, with the Accelerometer sensing the acceleration and providing a sensed acceleration output signal as an input to the Signal Processor. The method then continues to step (305) with the Signal Processor sampling the accelerometer acceleration output signal. The method then continues to step (306) with the Signal Processor decoding and scaling the sampled accelerometer signal, applying digital filters to the decoded and scaled accelerometer signal, and then calculating an Accelerometer Reference signal. In the preferred embodiment the Accelerometer Reference Signal is the Horizontal and Vertical attitude of the accelerometer, in an alternate embodiment the Accelerometer Reference Signal is determined from a single accelerometer output along the accelerometer sense axis. The method continues to step (307) with the Signal Processor selecting an Accelerometer Reference Signal and applying the Accelerometer Reference Signal to a selected Schedule for each Motor, to determine a motor reference speed to provide as output to each Motor Speed Controller. Subprocess 1 then continues to step (304) as long as the device remains in the Device Active State (302). The method then continues to step (308) with Subprocess 2 with each Electronic Motor Speed Controller receiving a Motor Speed Reference from step (307) for each motor it controls, and the motor speed controller then regulates the power applied to the motor in the form of voltage and current from the Power Source to each motor the Electronics Motor Speed Controller control in order to achieve the commanded Motor Reference Speed.

The method continues to step (309) where the rotating shaft of each motor in the device rotates at the commanded Motor Reference Speed. The method continues to step (310) where each rotating shaft of each motor is mechanically coupled to an implement. The method continues to step (311) where the implement operates at the scheduled speed operating point. At anytime the device is in the Active State (302), if the Power Switch state changes from the ON to the OFF State, then the method will exit the Device in Active State (302) and enter the Device Inactive state (312). When the Device enters the Inactive state (312), the method continues to step (313), where the Electronics Control Module receives the Power Switch signal in the OFF state, and the Electronics Control Module removes conditioned power from the power source, which removes power from the Accelerometer, Signal Processor and Electronic Motor Speed Controller. The method continues to step (314) where the Device and Implement is nonoperative.

Although the invention has been explained in relation to its preferred embodiment, it is to be understood that many other possible modifications and variations can be made without departing from the spirit and scope of the invention. The following sections will now describe the invention for example devices with example implements.

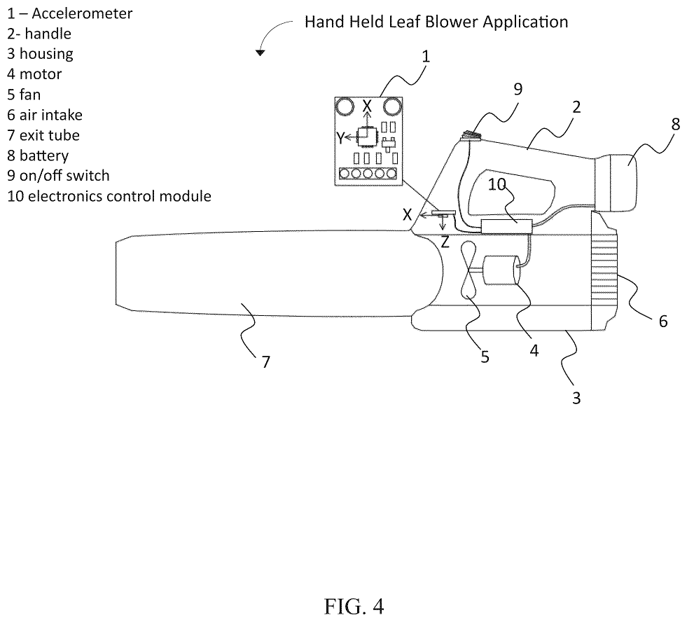

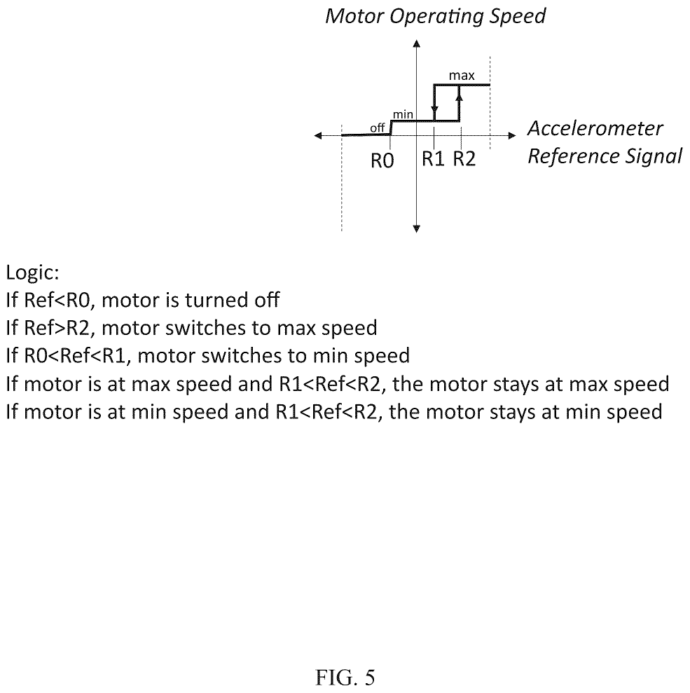

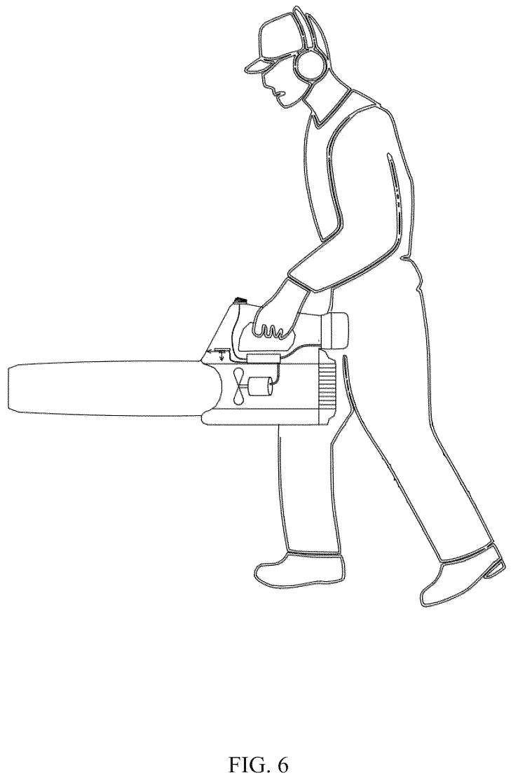

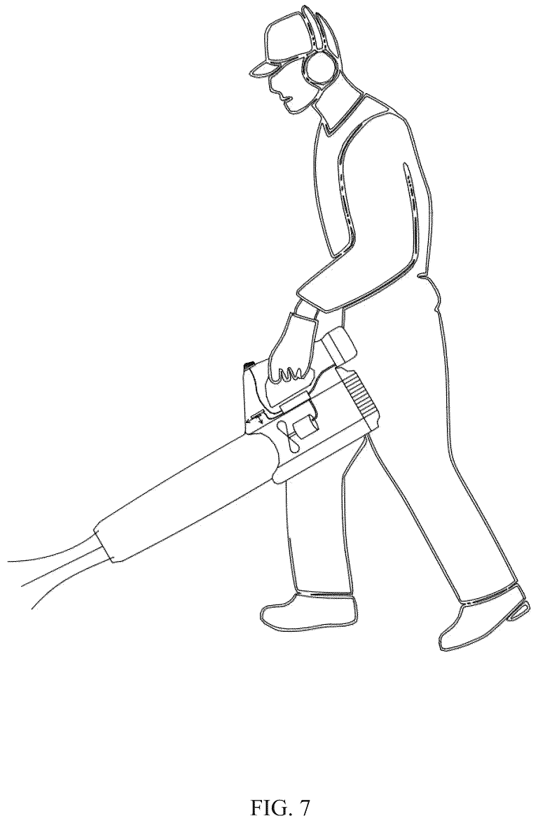

For example, in one Device application, as shown in FIG. 4, the Device is a battery powered leaf blower, with a motor driven Fan as the implement. The accelerometer (1) is mounted within the handle (2) which is mechanically connected to the device housing (3) and aligned with the housing (3) such that the X sense axis of the accelerometer is along the forward axis of the housing, the Y sense axis of the accelerometer is aligned with the right and left axis of the housing, and the Z sense axis of the accelerometer is aligned with the up and down axis of the housing. When the motor (4) rotates, it turns a fan (5) which generates air flow that enters the air intake (6) and exists the exit tube (7) at a higher speed, with the volume and speed of air flow that is proportional to the rotating speed of the motor and fan. An externally mounted battery (8) provides power for the operation of the device. When the ON/OFF switch (9) is in the ON state, this activates the electronics control module (10) which contains a signal processor and electronics motor speed controller, and provides power to the accelerometer (1). With the accelerometer in the placement and orientation depicted in FIG. 4, when the device is in a horizontal orientation the outputs of the accelerometer in the X, Y and Z axis direction are as follows: the X and Y axis output signal a will indicate 0 g's, and the Z axis accelerometer will output a signal indicating 1 g. The signal processor will receive accelerometer outputs in X, Y, and Z directions, and will process the signals to determine the device orientation by taking the arc tangent of the ratio of the X output and the Z output. The orientation can also be determined by simply processing the X axis accelerometer or the Z accelerometer individually. The preferred embodiment of this invention is to process the arc tangent of the ratio of the X output and the Z output because this provides more immunity to accelerometer measurement error. In either embodiment, the signal processor can determine an accelerometer reference signal by processing one or more accelerometer outputs that will indicate the orientation of the device. The accelerometer reference signal is then used an input to a preprogrammed schedule contained within the signal processor to determine the operating motor speed command for this device. In FIG. 5, depicts a preprogrammed schedule of operating motor speed that is scheduled as a response to the selected accelerometer reference signal. For example, the Signal Processor reads the X axis and Z axis Accelerometer signal and creates an Accelerometer Reference Signal that is the Arc Tangent of the ratio of the X axis output divided by the Z axis output. With this arrangement of components, the said Accelerometer Reference signal will range from a minimum of −1 g when the device is pointed UP, to 0 g when the device is horizontal and +1 g when the device is pointed DOWN. The preprogrammed schedule of Commanded Motor Operating Speed will respond to the Accelerometer Reference Signal according to FIG. 5. If the Reference signal is below R0, indicating the device is pointed UP, the commanded Motor Operating Speed will be zero. When the device is held in a nearly Horizontal orientation as shown in FIG. 6, the Accelerometer Reference signal will be between R0 and R1 indicating nearly horizontal orientation, the commanded Motor Operating Speed will be at a minimum preprogrammed value, which could be from zero to a fraction of the maximum rotating speed. When the device is oriented towards the ground as shown in FIG. 7, the Accelerometer Reference signal will be greater than R2, indicating the device is pointed towards the ground, and the commanded Motor Operating Speed will be the Maximum Operating Speed. The device orientation is expected to vary between horizontal orientation and being pointed towards the ground as the device is being used, in this region of operating variation, the Accelerometer Reference signal will be varying between R1 and R2, and as such the commanded Motor Operating Speed will remain at the previously commanded Operating Speed in order to enhance the usability of the device. Referring back to FIG. 4, the signal processor then provides the commanded motor operating speed to the motor speed controller, which regulates the power from the Battery (8) in order to achieve the commanded motor operating speed. The Motor (4) is mechanically connected to the Fan (5), so that when the Motor (4) rotates this causes the Fan (5) to rotate, which generates air flow that enters the Intake (6) of the device and exits the Exit Tube (7) at a higher speed. In this way, the user need only control the horizontal orientation of the device, and the commanded Motor Operating Speed will change in an acceptable manner based on the orientation sensed by the Accelerometer and determined by the pre-programmed schedule, thus eliminating the need for a trigger to be depressed or released in order to perform the desired function of the Device.

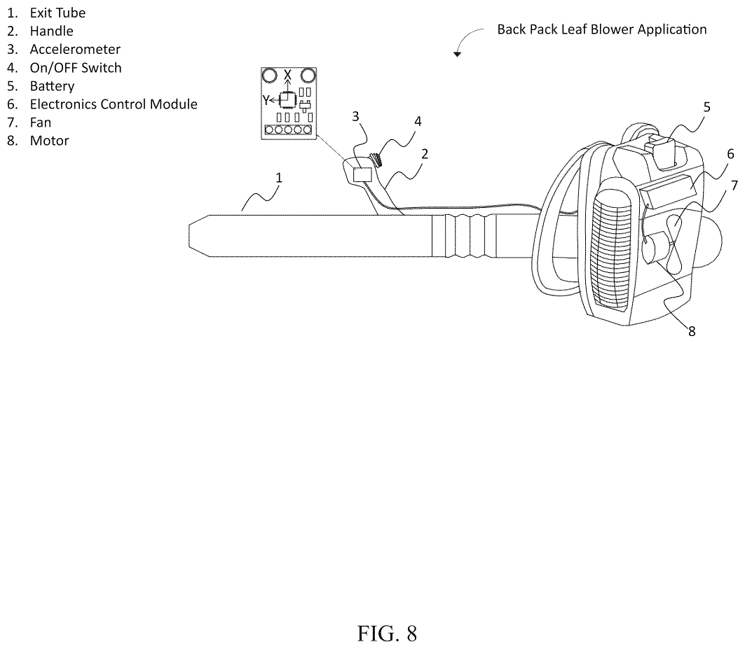

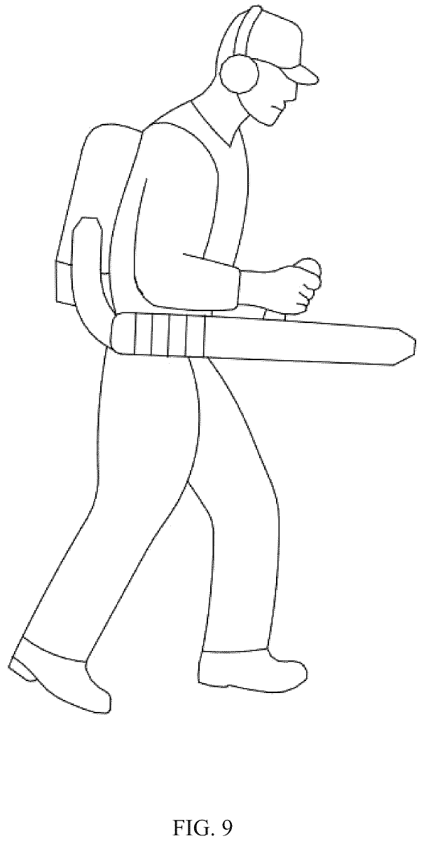

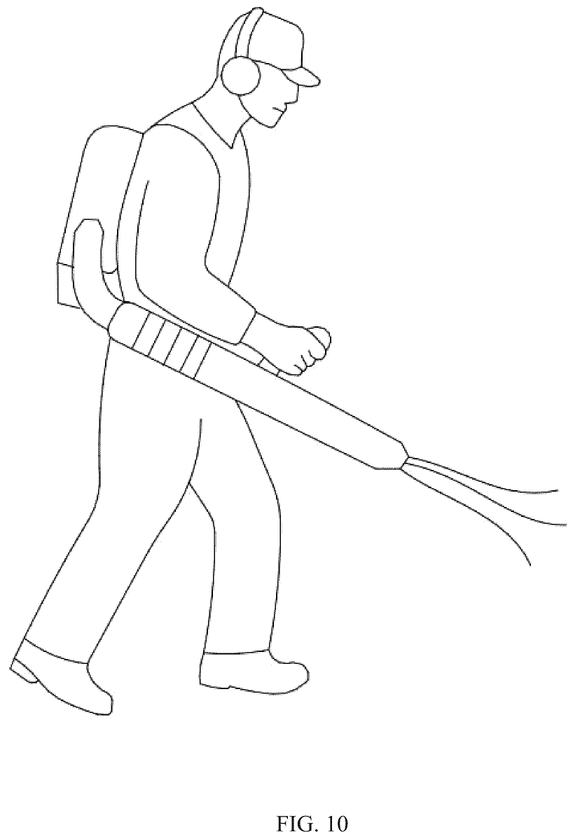

In yet another Device application, as shown in FIG. 8, the Device is a battery powered back pack leaf blower with an articulated Exit Tube (1) that contains a Handle (2) attached to the Exit Tube (1), an Accelerometer (3) located within the Handle (2), an ON/OFF Switch (4) on the Handle (2), a Battery (5) as the power Source, an Electronics Control Module (6) which contains a Signal Processor and Electronic Motor Speed Controller, and the implement is a Fan (7) that is mechanically coupled to the rotating shaft of a Motor (8). To properly operate this device, the preprogrammed schedule of commanded motor rotating speed is a function of the accelerometer outputs that will increase the commanded motor rotating speed as the handle goes from a horizontal orientation to an orientation that points towards the ground. For example, when the Signal Processor within the Electronics Control Module (6) receives the Accelerometer (3) output signals in the X sense axis and the Z sense axis, the Signal Processor creates an Accelerometer Reference Signal that is the Arc Tangent of the ratio of the X axis output divided by the Z axis output. With this arrangement of components, the said Accelerometer Reference signal will range from a minimum of −1 g when the Exit Tube (1) is pointed UP, to 0 g when the Exit Tube is horizontal and +1 g when the Exit Tube (1) is pointed DOWN towards the ground. Referring back to FIG. 5, the preprogrammed schedule of commanded Motor Operating Speed will respond to the Accelerometer Reference Signal with thresholds for R0, R1 and R2 tailored for the Device. When the Exit Tube (1) is oriented such that it is pointed UP, the Accelerometer Reference signal will be below R0 indicating the Exit Tube is pointed UP, and the commanded Motor Operating Speed will be zero. When Exit Tube (2) is oriented in the horizontal position, the Accelerometer Reference signal will be between R0 and R1, indicating the Exit Tube is nearly Horizontal as shown in FIG. 9, and the commanded Motor Operating Speed will be rotating at a minimum preprogrammed value, which could be from zero to a fraction of the maximum rotating speed. When the Exit Tube (2) is oriented towards the ground, the Accelerometer Reference signal will be greater than R2, indicating the Exit Tube is oriented towards the ground as shown in FIG. 10, and the commanded Motor Operating Speed will be commanded to the Maximum Operating Speed. When the Accelerometer Reference signal is between R1 and R2, this is the region where the user will be pointing the device towards the ground and will vary according to the environment in which the device is operating, and as such the commanded Motor Operating Speed will remain at the previous commanded Operating Speed. In this way, the user need only control the vertical and horizontal orientation of the Exit Tube, and the commanded Motor Operating Speed will change in an acceptable manner based on the orientation sensed by the Accelerometer and determined by the pre-programmed schedule, thus eliminating the need for a trigger to be depressed or released in order to perform the desired function of the Device.

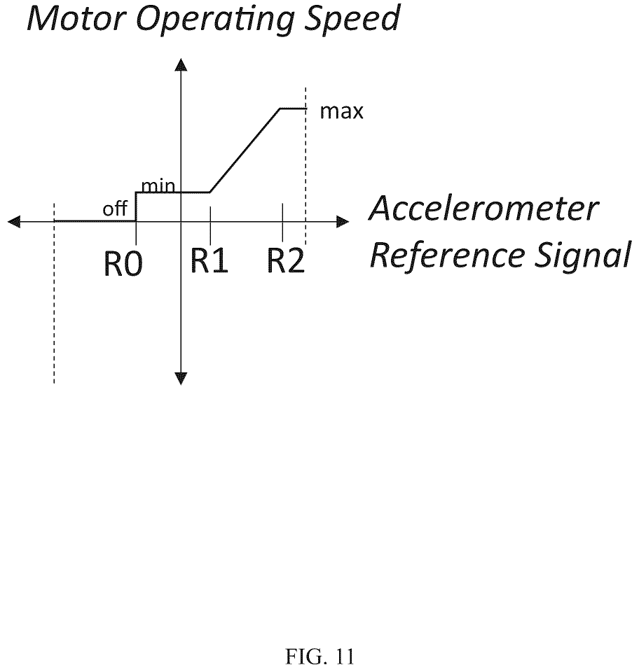

The pre-programmed schedule in FIG. 5 is a simplified illustration of how the commanded motor operating speed can be scheduled as a response to the Accelerometer outputs that form an Accelerometer reference signal. However, it is not the only such schedule that could be determined and tailored based on the Device being controlled. For example, an alternate reference schedule could have a proportional region, where the operating motor speed gradually increases as shown in FIG. 11. In this schedule, the commanded Motor Operating Speed will respond to the Accelerometer Reference Signal with thresholds for R0, R1 and R2 tailored for the Device. If the Reference signal is below R0, the commanded Motor Operating Speed will be zero. When the Accelerometer Reference signal is between R0 and R1, the commanded Motor Operating Speed will be rotating at a minimum preprogrammed value, which could be from zero to a fraction of the maximum rotating speed. When the Accelerometer Reference signal is between R1 and R2, the commanded Motor Operating Speed will proportionally increase from the Minimum Operating Speed to the Maximum Operating Speed, allowing the user to gradually increase the Motor Operating Speed as the Accelerometer Reference Signal Increases. When the Accelerometer Reference Signal exceeds R2, the commanded Motor Operating Speed will be the maximum value. In this way, the user need only control the orientation of the Exit Tube (2) of the device, and the Motor Operating Speed will change in a more gradual manner based on the orientation sensed by the Accelerometer and determined by the pre-programmed schedule, thus eliminating the need for a trigger to be depressed or released in order to perform the desired function of the Device.

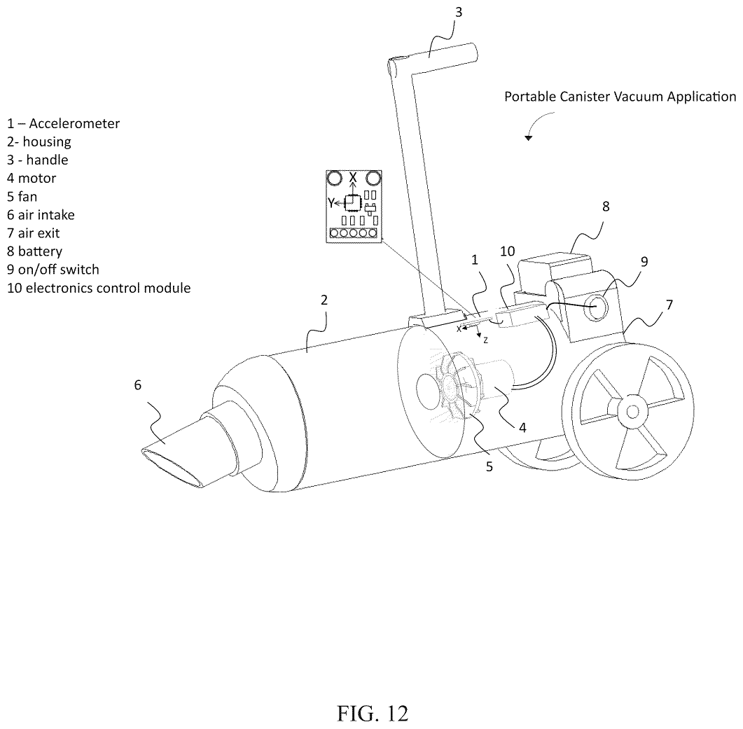

In another Device application, as shown in FIG. 12, the Device is a battery powered portable canister vacuum, with a motor driven Fan as the implement. The accelerometer (1) is mounted within the housing (2), and has a handle (3) mechanically connected to the housing (2). The accelerometer (1) and aligned with the housing (2) such that the X axis of the accelerometer is along the forward axis of the housing, the Y axis of the accelerometer is aligned with the right and left axis of the housing, and the Z axis of the accelerometer is aligned with the up and down axis of the housing. When the motor (4) rotates, it turns a fan (5) which generates air flow that enters the air intake (6) and exits the rear of the canister housing (7), with the volume and speed of air flow that is proportional to the rotating speed of the motor and fan. An externally mounted battery (8) provides power for the operation of the device. When the On/Off switch (9) is in the ON state, this activates the electronics control module (10) which contains a signal processor and electronics motor speed controller, and provides power to the accelerometer (1). With the accelerometer in the placement and orientation depicted in FIG. 12, the horizontal orientation of the device can be determined by processing the outputs of the accelerometer in the X and Z axis. The signal processor will receive accelerometer outputs in X, Y, and Z directions, and will process the signals to determine the device's horizontal orientation by taking the arc tangent of the ratio of the X output and the Z output. The orientation can also be determined by simply processing the X axis accelerometer or the Z accelerometer individually. The preferred embodiment of this invention is to process the arc tangent of the ratio of the X output and the Z output because this provides more immunity to accelerometer measurement error. In either embodiment, the signal processor can determine an accelerometer reference signal by processing one or more accelerometer outputs that will indicate the horizontal orientation of the device. In this preferred embodiment, the signal processor will determine an accelerometer reference signal by taking the arc tangent of the ratio of the X accelerometer output divided by the Z accelerometer output, and apply the accelerometer reference signal to the programmable schedule in FIG. 5 to determine a commanded motor speed in accordance with the schedule.

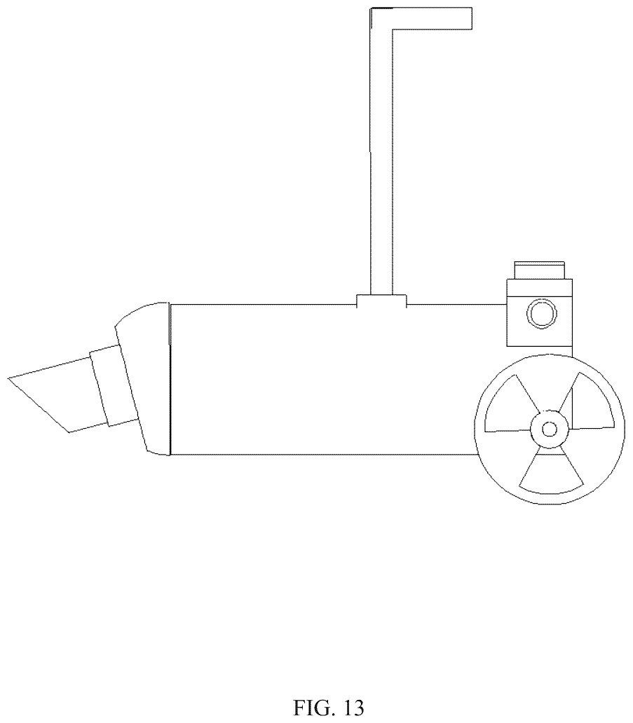

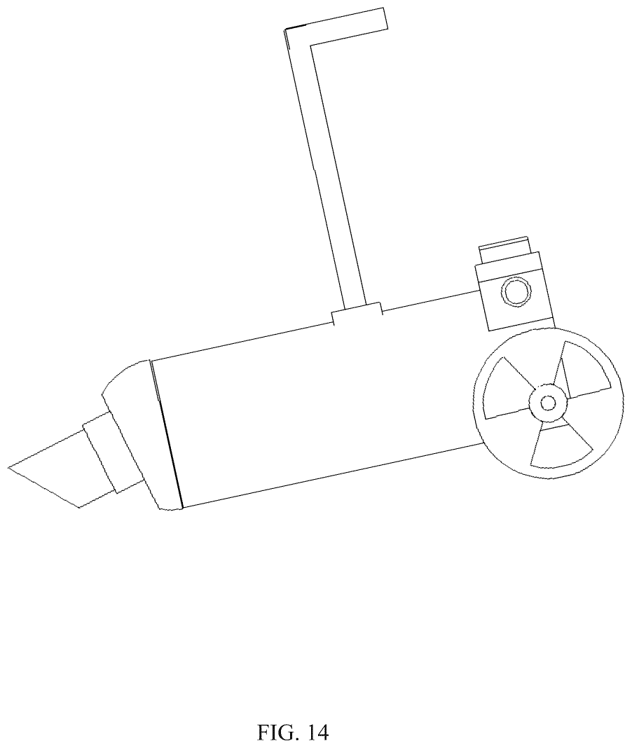

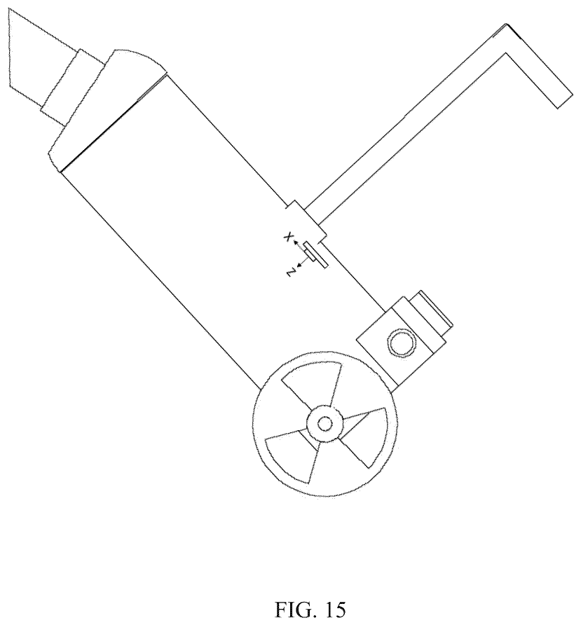

With this arrangement of components, the said Accelerometer Reference signal will range from a minimum of 0 g when the device is in a horizontal orientation, as shown in FIG. 13, and increase to a fraction of +1 g when the device is oriented from a horizontal orientation to a downward orientation as shown in FIG. 14. When the device changes from a horizontal orientation shown in FIG. 13 to an upward orientation shown in FIG. 15, the accelerometer reference signal will change from 0 g's to fraction of −1 g. Following the preprogrammed schedule of commanded motor operating Speed in FIG. 5, when the accelerometer reference signal is below R0, indicating the device is pointed UP as shown in FIG. 15, the motor operating speed will be commanded to zero. When the Accelerometer Reference signal is between R0 and R1, indicating the device is nearly Horizontal as shown in FIG. 13, and the motor operating speed will be commanded to a minimum preprogrammed value, which could be from zero to a fraction of the maximum rotating speed. When the accelerometer reference signal is greater than R2, indicating the device is oriented towards the ground as shown in FIG. 14, the motor operating speed will be commanded to the maximum operating speed. When the accelerometer reference signal is between R1 and R2, this is the region where the user is expected to be pointing the device towards the ground with some variation in the orientation according objects the device is being used to manipulate, and as such the motor operating speed will commanded to the previously commanded motor operating speed. The signal processor then provides the commanded motor operating speed to the electronic motor speed controller, which regulates the power from the battery in order to achieve the commanded motor operating speed. The motor is mechanically connected to the fan, so that when the motor rotates this causes the fan to rotate, which generates air flow that enters the intake of the device, creating suction at the intake, and air continues to pass through the canister and finally exits the device at the rear exit vent. In this way, the user need only control the horizontal orientation of the device, and the motor operating speed will change in an acceptable manner based on the orientation sensed by the accelerometer and determined by the pre-programmed schedule, thus eliminating the need for a trigger to be depressed or released in order to perform the desired function of the device.

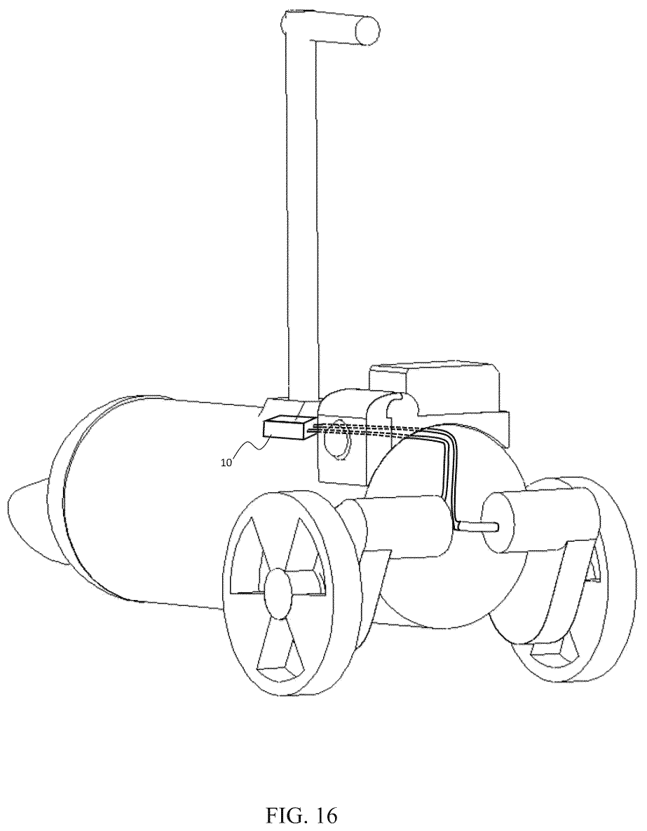

In another Device application, as shown in FIG. 16, the Device is a battery powered portable canister vacuum as earlier described in FIG. 12, but with motorized wheels added as additional implement to be controlled. The accelerometer (1) is mounted within the housing (2), and a handle (3) is mechanically connected to a housing (2). The accelerometer (1) is aligned with the housing (2) such that the X axis of the accelerometer is along the forward axis of the housing, the Y axis of the accelerometer is aligned with the right and left axis of the housing, and the Z axis of the accelerometer is aligned with the up and down axis of the housing. When viewing the left wheel (4) from the left side of the device, rotation of the left motor (5) in the counter clockwise direction is transmitted through a gear box which causes the left wheel to also rotate in a counter clockwise direction which produces forward motion. When viewing the right wheel (6) from the right side of the device, rotation of the right motor (7) in the clockwise direction is transmitted through a gear box which causes the right motor to rotate in a clockwise direction which produces a forward motion of the right wheel. By convention, when forward motion is desired, the direction of rotation of the left and right motors will be controlled in the direction required to produce forward motion. When reverse direction is desired, the direction of rotation of the left and right motors will be controlled in the direction required to produce reverse motion.

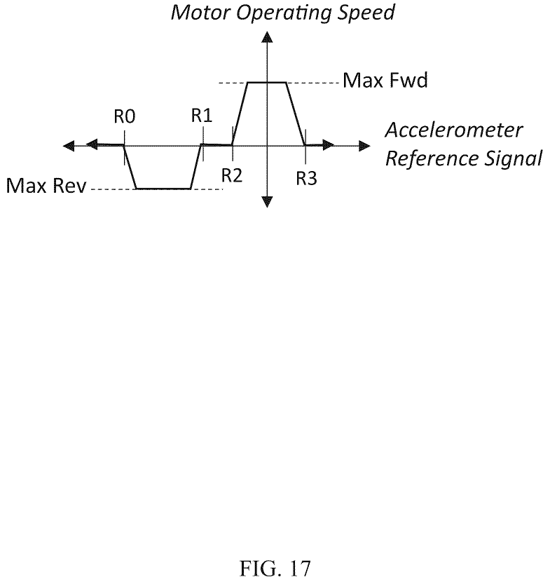

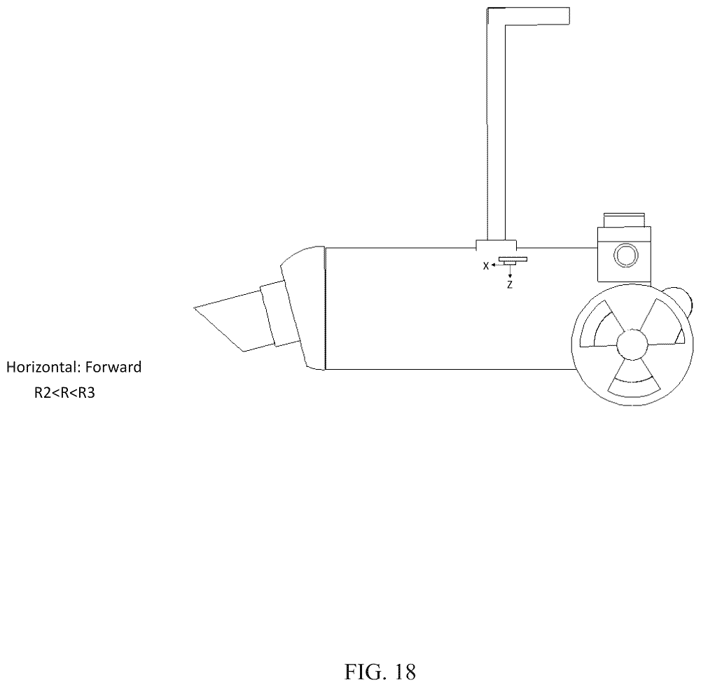

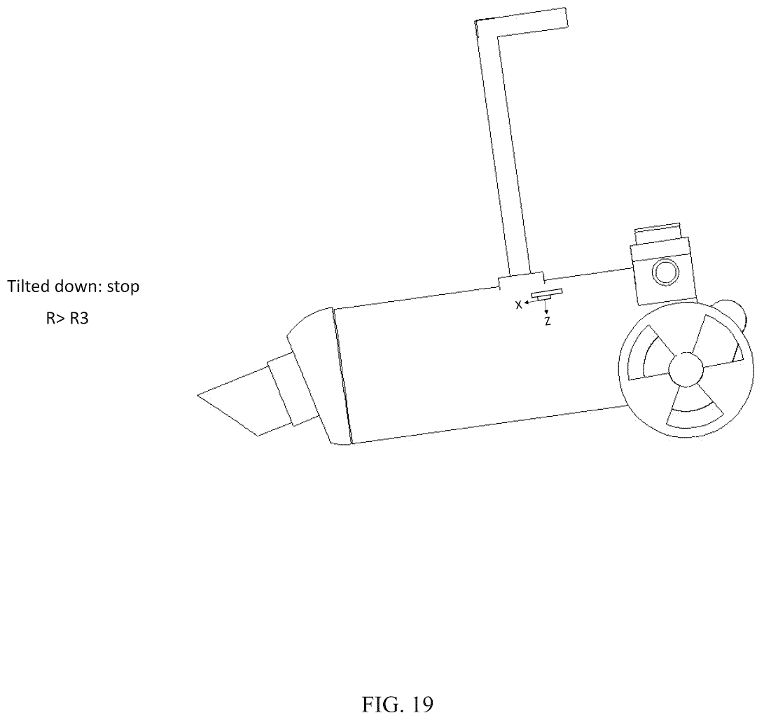

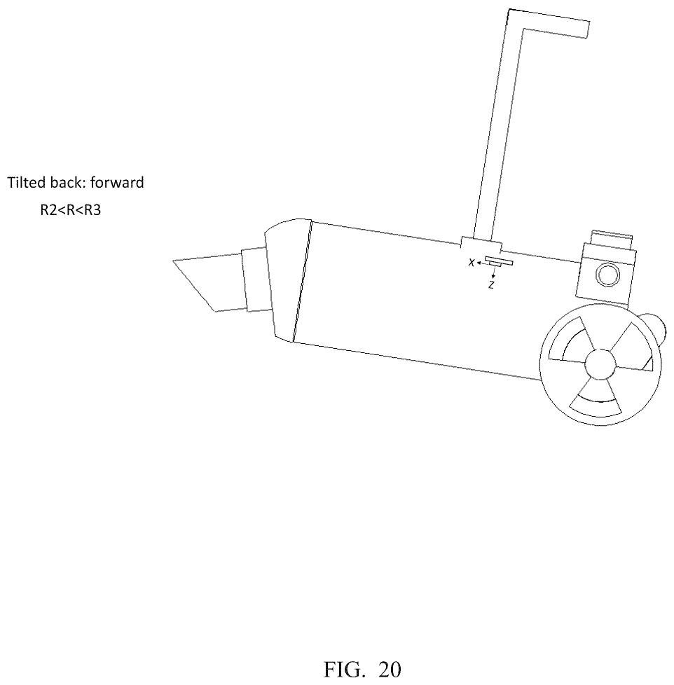

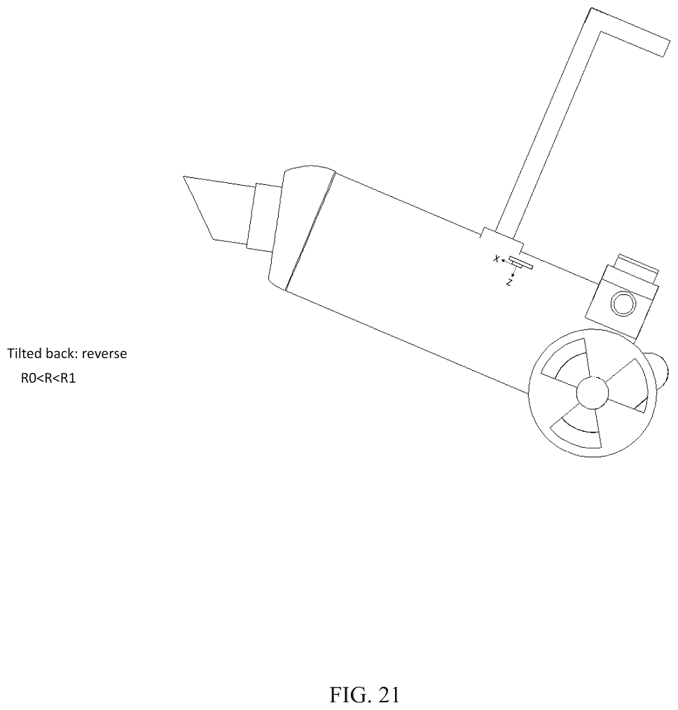

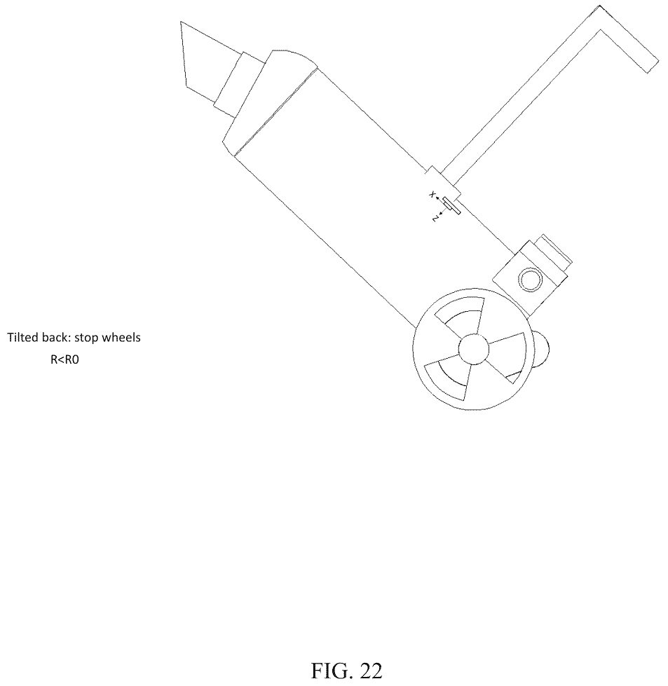

An externally mounted battery (8) provides power for the operation of the device. When the On/Off switch (9) is in the ON state, this activates the electronics control module (10) which contains a signal processor and two electronics motor speed controllers, one for each motor, and provides power to the accelerometer (1). With the accelerometer in the placement and orientation depicted in FIG. 16, the horizontal orientation of the device can be determined by processing the outputs of the accelerometer in the X and Z axis. The signal processor will receive accelerometer outputs in X, Y, and Z directions, and will process the signals to determine the device's horizontal orientation by taking the arc tangent of the ratio of the X output and the Z output. The orientation can also be determined by simply processing the X axis accelerometer or the Z accelerometer individually. The preferred embodiment of this invention is to process the arc tangent of the ratio of the X output and the Z output because this provides more immunity to accelerometer measurement error. In either embodiment, the signal processor can determine an accelerometer reference signal by processing one or more accelerometer outputs that will indicate the horizontal orientation of the device. In this preferred embodiment, the signal processor will determine an accelerometer reference signal by taking the arc tangent of the ratio of the X accelerometer output divided by the Z accelerometer output, and apply the accelerometer reference signal to the programmable schedule in FIG. 17 to determine a commanded motor speed and direction to each motor in accordance with the schedule. With this arrangement of components, the said accelerometer reference signal will range from of 0 g's when the device is in a horizontal orientation, as shown in FIG. 18, and increase to a fraction of +1 g when the device is oriented from a horizontal orientation to a downward orientation as shown in FIG. 19. When the device changes from a horizontal orientation shown in FIG. 18 to a pointing upward orientation shown in FIGS. 20, 21, and 22, the accelerometer reference signal will proportionally change from 0 g's to fraction of −1 g as the device orientation continues to increase in the upward pointing direction. Following the preprogrammed schedule of commanded motor operating speed and direction in FIG. 17, when the accelerometer reference signal is greater than R3, the device is pointed down as shown in FIG. 19, and the commanded speed and direction for the motors is zero, producing no forward or reverse motion. When the accelerometer reference signal is between R2 and R3, the device is nearly horizontal to the slightly pointed up orientation, as shown in FIG. 18 and the commanded speed and direction for the motors is in the forward direction. When the accelerometer reference signal is between R1 and R2, the commanded speed and direction for the motors is zero, producing no forward or reverse motion. When the accelerometer reference signal is between R0 and R1, the device is pointed further in the upwards direction, as shown in FIG. 21, and the commanded speed and direction of the motors is in the reverse direction. When the accelerometer reference signal is below R0, the device is pointed further in the up direction, as shown in FIG. 22, and the commanded speeds and directions of the motors is zero, producing no forward or reverse motion. The signal processor then provides the commanded motor operating speed and direction to each electronic motor speed controller, which regulate the power from the battery in order to achieve the commanded motor operating speed and direction to each motor. The motors are mechanically connected to wheels through gear box on each motor, so that when each motor rotates this causes each wheel to rotate in the proper direction to create forward or reverse motion of the device. In this way, the user need only control the horizontal orientation of the device, and each motor operating speed and direction will change in an acceptable manner based on the orientation sensed by the accelerometer and determined by the pre-programmed schedule, thus eliminating the need for a separate trigger to be depressed or released in order to perform the desired function of the device.

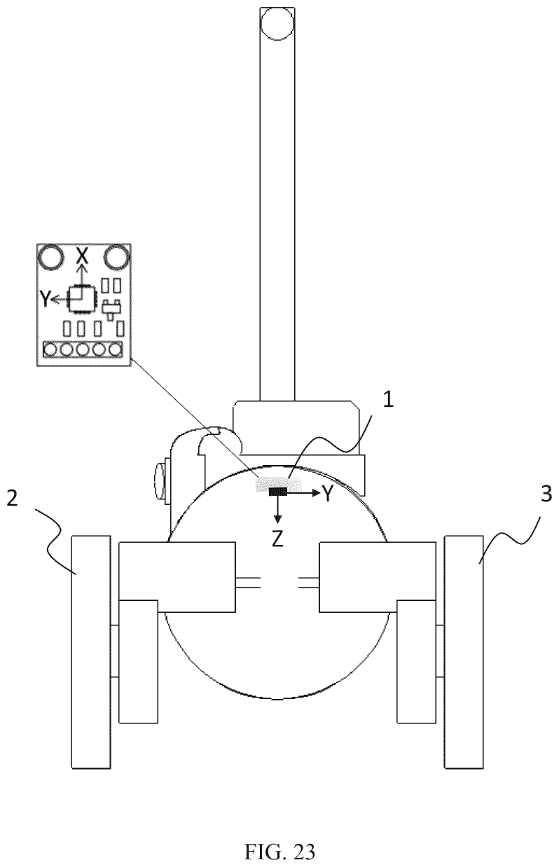

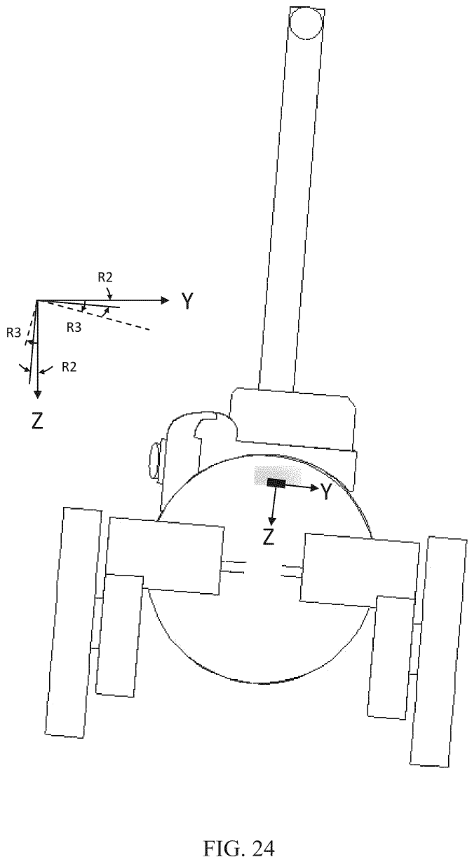

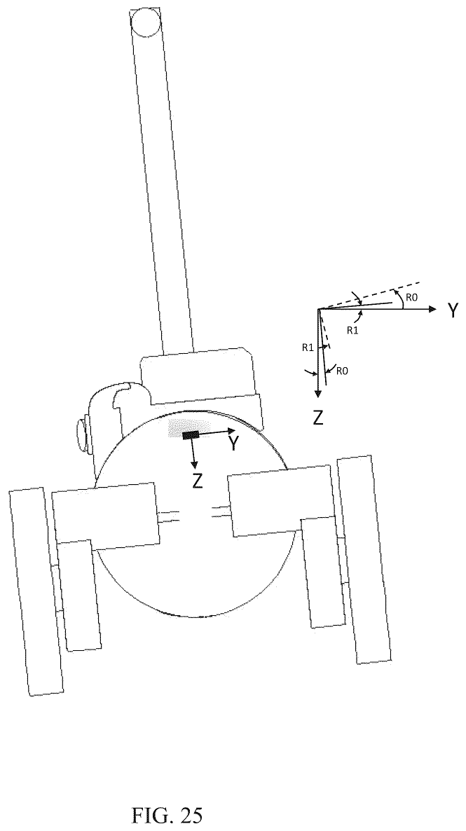

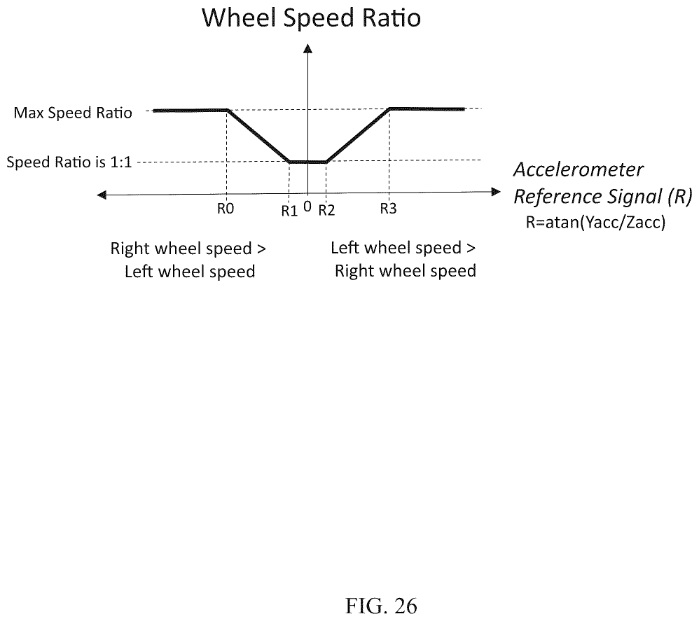

Continuing with the device described in FIG. 16, the accelerometer outputs can be further processed to determine if the device is being tilted to the left or the right of vertical, and adjust the commanded speeds to the motors to allow for the user to manipulate the steering of the device to the left or right directions. To accomplish this, the accelerometer reference signal is determined by taking the arc tangent of the ratio of the Y axis output divided by the Z axis output. In this manner a left or right tilt of the device can be measured in order to generate a command to each motorized wheel for the purpose of steering the device in the left or right directions. In FIG. 23, the device in FIG. 16 is shown from the rear, facing forward orientation. The accelerometer Y axis positive direction is shown pointing to the right of the device while the accelerometer Z axis positive direction is shown pointing in the downward direction. FIG. 23 is for the device in a vertical orientation without a left or right tilt. FIG. 24 is for the device tilted to the right, and FIG. 25 is for the device tilted to the left. When the device is vertically oriented as shown in FIG. 23, the accelerometer vertical orientation reference signal is 0 g's, then as the device tilts to the right as shown in FIG. 24, the accelerometer vertical orientation reference signal increases from 0 g's to a fraction of +1 g, proportionally increasing in the positive g direction as the tilt to the right continues to increase. When the device is tilted to the left as shown in FIG. 25, the accelerometer vertical orientation reference signal increases from 0 g's to a fraction of −1 g, and proportionally increases in the negative g direction as the tilt to the left continues to increase. In this manner, the Y axis and Z axis outputs of the accelerometer can be used to generate an accelerometer vertical orientation reference signal to detect the tilt angle from left, to vertical, to the right. When the device is tilted to the left, this will result in steering the device to the left, and when tilted to the right, the device will be steered in the right direction. In order for the device to be steered in the left or right directions, it is required that the speeds of each motor driven wheel to be different, or have a differential speed ratio. For example, to steer to the left, the right wheel must rotate at a higher speed than the left wheel, or the ratio of the right wheel speed divided by the left wheel speed is greater than one. Likewise, to steer to the right, the left wheel must rotate at a faster speed than the right wheel, or the ratio of the left wheel speed divided by the right wheel speed is greater than one. In order to maintain desired forward or reverse motion, the ratio of the rotating speeds will be considered as control reference. Thus to steer to the left the ratio of the right wheel speed divided by the left wheel speed will be greater than 1. To steer to the right, the ratio of the left wheel speed divided by the right wheel speed will be greater than 1. To move in the forward or reverse directions without steering to the left or to the right, the ratio of the left wheel speed divided by the right wheel speed is 1. Therefore to accomplish a left or right steering action, the accelerometer reference signal will be the ratio of the arc tangent of the Y accelerometer output signal divided by the Z accelerometer output to determine a tilt angle, and this reference signal will be used to schedule the ratio of the wheel speeds in a manner that achieves the steering direction indicated by the left or right tilt angle of the device, with the schedule for the ratio of wheel speeds as shown in FIG. 26. For example, when the device is vertically oriented, and not significantly tilted to the left or right, the orientation will be as shown in FIG. 23, and the accelometer vertical orientation reference signal will be between R1 and R2 as shown in FIG. 26, and the commanded speed ratio of the wheel speeds will be 1, thus the right wheel (3) and left wheel (2) commanded speeds will be equal, maintain forward or reverse motion without steering to the left or the right directions.

When the device is being tilted to the right as shown in FIG. 24, and the accelerometer reference signal is between R2 and R3 as shown in FIG. 26, indicating the device is being tilted to the right, the schedule of the ratio of wheel speeds will command the ratio of the left wheel speed divided by the right wheel speed to be greater than 1, up to the maximum speed ratio allowed in the schedule, thus allowing the device to steer to the right. When the device is being tilted to the left as shown in FIG. 25, and the accelerometer reference signal is between R0 and R1 as shown in FIG. 26, indicating the device is being tilted to the left, the schedule of the ratio of wheel speeds will command the ratio of the right wheel speed divided by the left wheel speed to be greater than 1, up to the maximum speed ratio allowed in the schedule, thus allowing the device to steer to the left. The wheel speed and direction for the left wheel is controlled by the speed and direction of rotation of the left motor that is mechanically coupled to the left wheel through a gear box coupling, and likewise, the wheel speed and direction for the right wheel is controlled by the speed and direction of rotation of the right motor that is mechanically coupled to the right wheel through a gear box coupling. The signal processor then provides the commanded motor operating speed and direction to each electronic motor speed controller, which regulates the power from the battery in order to achieve the commanded motor operating speed and direction to each motor. The motors are mechanically connected to wheels through a gear box on each motor, so that when each motor rotates in the commanded speed and direction, this causes each wheel to rotate in the direction and speed to create forward or reverse motion, and the commanded steering direction of the device. In this way, the user need only control the tilt orientation of the device, and each motor operating speed and direction will change in an acceptable manner based on the vertical tilt orientation indicated by the accelerometer and determined by the pre-programmed schedule, thus eliminating the need for a separate complex steering mechanism such as a joy stick, or separate buttons to be manipulated by the operator in order to perform the desired steering function of the device.

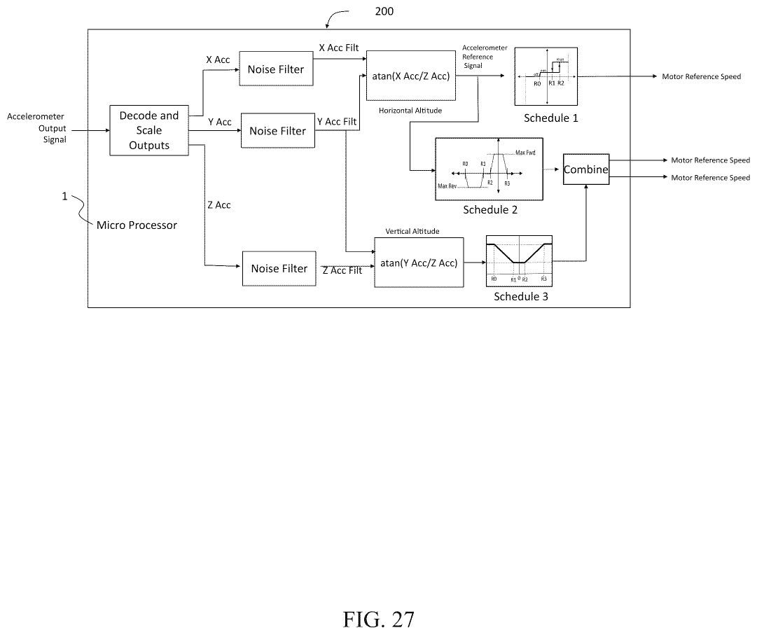

Finally, as illustrated in FIG. 27, the accelerometer controlled device comprises a plurality of motors, with one motor rotating a fan and controlled by schedule 1, and two additional motors rotating wheels and controlled by a forward and reverse speed schedule, shown as schedule 2, and a wheel speed ratio schedule shown as schedule 3. In this manner, the plurality of motorized implements is controlled by the outputs of a single three axis accelerometer.

Although the invention has been explained in relation to its preferred embodiment, it is to be understood that many other possible modifications and variations can be made without departing from the spirit and scope of the invention as hereinafter claimed.

What is claimed is:

1. An accelerometer controlled rotating motor speed system comprising:
at least one accelerometer;
at least one motor;
at least one implement;
at least on signal processor,
at least one electronic motor speed controller;
a power switch;
a power source;
at least one handle connected to a housing;
the at least one handle allowing the user to control the attitude orientation of the device;
the at least one accelerometer being mechanically connected to the at least one housing;
the at least one accelerometer being electronically connected to the at least one signal processor;
the at least one electronic motor speed controller being electronically connected to the at least one motor, the at least one signal processor, and the power source;
the power switch activating the device being controlled;
the power source being electrically connected to the at least one motor, the at least one signal processor, the at least one electronic motor speed controller, and the power switch;
the at least one motor is mechanically coupled to the at least one implement; and
the at least one signal processor determines the commanded motor operating speed with a programmed schedule of motor operating speed verses accelerometer output.

2. The accelerometer controlled rotating motor speed system as claimed in claim 1 wherein the accelerometer output is the acceleration due to gravity along at least one axis of the device.

3. The accelerometer controlled rotating motor speed system as claimed in claim 1 wherein the at least one implement comprising a motorized fan.

4. The accelerometer controlled rotating motor speed system as claimed in claim 3 wherein the schedule of motor operating speed verses accelerometer output contains regions where the commanded motorized fan operating speed is proportionally changing with accelerometer output.

5. The accelerometer controlled rotating motor speed system as claimed in claim 3 wherein the schedule containing regions below a threshold of accelerometer output where the commanded motorized fan operating speed is a minimum value.

6. The accelerometer controlled rotating motor speed system as claimed in claim 3 wherein the schedule containing a region above a threshold of accelerometer output where the commanded motorized fan operating speed is a maximum value.

7. The accelerometer controlled rotating motor speed system as claimed in claim 3 wherein the schedule containing hysteresis of commanded motorized fan operating speed versus accelerometer output.

8. The accelerometer controlled rotating motor speed system as claimed in claim 3 wherein the programmed schedule of commanded motorized fan operating speed being an arbitrary function of accelerometer output.

9. The accelerometer controlled rotating motor speed system as claimed in claim 2 wherein the least one implement comprising a plurality of motorized wheels.

10. The accelerometer controlled rotating motor speed system as claimed in claim 9 wherein the accelerometer output being the acceleration due to gravity along at least one axis of the device.

11. The accelerometer controlled rotating motor speed system as claimed in claim 9 wherein the schedule of motor operating speed verses accelerometer output containing regions where the commanded motorized wheel operating speed proportionally changes with accelerometer output.

12. The accelerometer controlled rotating motor speed system as claimed in claim 9 wherein the schedule containing regions of accelerometer output where the commanded motorized wheel operating speed is a zero.

13. The accelerometer controlled rotating motor speed system as claimed in claim 9 wherein the schedule containing a regions of accelerometer output where the commanded motorized wheel operating speed is a maximum value resulting in motion of the device in the forward direction.

14. The accelerometer controlled rotating motor speed system as claimed in claim 9 wherein the schedule containing a regions of accelerometer output where the commanded motorized wheel operating speed is a maximum value resulting in motion of the device in the reverse direction.

15. The accelerometer controlled rotating motor speed system as claimed in claim 9 wherein the programmed schedule of commanded motorized wheel operating speed and direction of motion of the device being an arbitrary function of accelerometer output.

16. The accelerometer controlled rotating motor speed system as claimed in claim 1 wherein the implement being two independently controlled motorized wheels.

17. The accelerometer controlled rotating motor speed system as claimed in claim 16 wherein the accelerometer output being the acceleration due to gravity along a longitudinal, a lateral and a vertical axis of the device.

18. The accelerometer controlled rotating motor speed system as claimed in claim 17 wherein where the programmed schedule of commanded motorized wheel operating speed in the forward or reverse direction of motion of the device being an arbitrary function of accelerometer output along the longitudinal axis.

19. The accelerometer controlled rotating motor speed system as claimed in claim 17 wherein the differential speed ratio of the motorized wheel speeds being a programmed schedule of the accelerometer outputs along the longitudinal and vertical axes.
